(19) United States
(12) Patent Application Publication
(10) Pub. No.: US 2018/0299989 A1
(43) Pub. Date: Oct. 18, 2018

(54) ELECTRONIC DEVICE, RECORDING MEDIUM, AND CONTROL METHOD

(71) Applicant: KYOCERA Corporation, Kyoto (JP)

(72) Inventors: Yuuya YAMAGUCHI, Yokohama-shi, Kanagawa (JP); Taro IIO, Yokohama-shi, Kanagawa (JP); Tsuneo MIYASHITA, Yokohama-shi, Kanagawa (JP); Ryohei NAKAMURA, Yokohama-shi, Kanagawa (JP)

(73) Assignee: KYOCERA Corporation, Kyoto (JP)

(21) Appl. No.: 15/948,858

(22) Filed: Apr. 9, 2018

(30) Foreign Application Priority Data
Apr. 12, 2017 (JP) 2017-079254

(51) Int. Cl. G06F 3/044

(52) U.S. Cl. CPC G06F 3/044

(57) ABSTRACT

An electronic device includes a proximity sensor, a touch sensor near the proximity sensor, and a controller configured to turn the proximity sensor off when it is determined, on the basis of an output of the touch sensor, that liquid is present on the electronic device at a location where the proximity sensor is disposed.

### CROSS-REFERENCE TO RELATED APPLICATION

The present application claims priority to and the benefit of Japanese Patent Application No. 2017-079254 filed Apr. 12, 2017, the entire contents of which are incorporated herein by reference.

### TECHNICAL FIELD

The present disclosure relates to an electronic device, a recording medium, and a control method.

### BACKGROUND

Electronic devices, such as smartphones and tablets, typically include a touch panel. A user typically controls such an electronic device by touching the touch panel. An electronic device that, for example, detects a gesture performed by the user at a distance from the terminal using a proximity sensor such as an infrared sensor and then processes an input operation corresponding to the gesture has been proposed in recent years.

### SUMMARY

An electronic device according to an embodiment comprises a proximity sensor; a touch sensor near the proximity sensor; and a controller. The controller is configured to turn the proximity sensor off when it is determined that liquid is present on the electronic device at a location where the proximity sensor is disposed on the basis of an output of the touch sensor.

A non-transitory computer-readable recording medium according to an embodiment includes computer program instructions to be executed by an electronic device comprising a proximity sensor, a touch sensor near the proximity sensor, and a controller, the instructions causing the electronic device to turn the proximity sensor off it is determined, using the controller, that liquid is present on the electronic device at a location where the proximity sensor is disposed on the basis of an output of the touch sensor.

A control method according to an embodiment is a control method for an electronic device comprising a proximity sensor, a touch sensor near the proximity sensor, and a controller, the control method comprising turning the proximity sensor off when it is determined, using the controller, that liquid is present on the electronic device at a location where the proximity sensor is disposed on the basis of an output of the touch sensor.

### BRIEF DESCRIPTION OF THE DRAWINGS

In the accompanying drawings:

FIG. 1 is a configuration diagram of an electronic device according to an embodiment;

FIG. 2 illustrates a user operating an electronic device with a gesture;

FIG. 3 is a configuration diagram of a proximity sensor;

FIG. 4 illustrates the change over time in the value detected by each infrared photodiode;

FIG. 5 illustrates an example of conditions in which an electronic device is operated with a gesture;

FIG. 6 schematically illustrates an electronic device on which a liquid is present;

FIG. 7 illustrates an example of one finger touching a touch panel display of an electronic device;

FIG. 8 illustrates an example distribution of the capacitance detected by a touch sensor in the state illustrated in FIG. 7;

FIG. 9 illustrates an example of two fingers touching the touch panel display of the electronic device;

FIG. 10 illustrates an example distribution of the capacitance detected by the touch sensor in the state illustrated in FIG. 9;

FIG. 11 illustrates an example of water being present on the touch panel display of the electronic device;

FIG. 12 illustrates an example distribution of the capacitance detected by the touch sensor in the state illustrated in FIG. 11;

FIG. 13 illustrates another example of water being present on the touch panel display of the electronic device;

FIG. 14 illustrates an example distribution of the capacitance detected by the touch sensor in the state illustrated in FIG. 13; and

FIG. 15 is a flowchart illustrating an example of processing executed by a controller of the electronic device.

### DETAILED DESCRIPTION

A conventional electronic device detects a gesture with a proximity sensor such as an infrared sensor. Consequently, if liquid such as water is present on the conventional electronic device at the location where the proximity sensor is disposed, then the infrared light may be defused or refracted by the liquid, preventing gestures from being detected accurately. When the electronic device cannot accurately detect gestures, the electronic device might perform a different operation than the operation intended by the user.

In light of these considerations, it would be helpful to provide an electronic device, a recording medium, and a control method that facilitate prevention of erroneous operation during gesture-based control.

(Electronic Device Configuration)

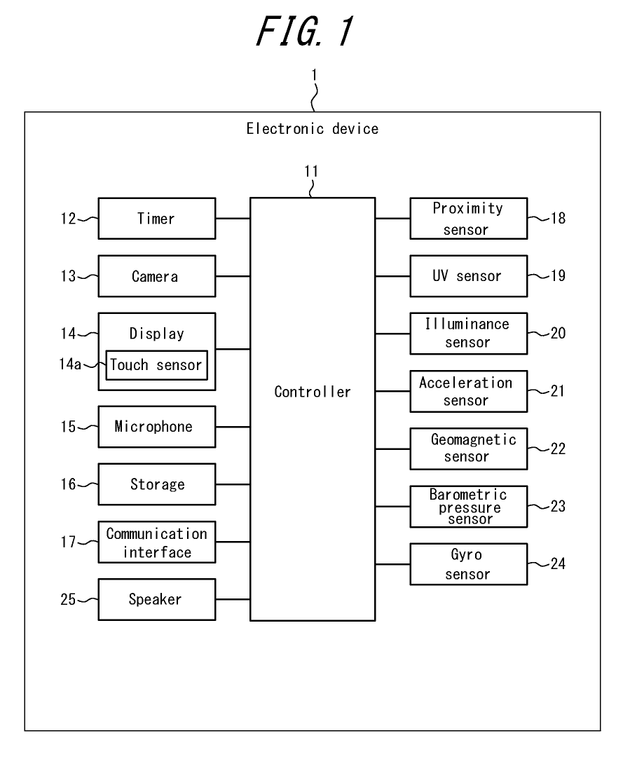

As illustrated in FIG. 1, an electronic device 1 according to an embodiment includes a timer 12, a camera 13, a display 14, a microphone 15, a storage 16, a communication interface 17, a speaker 25, a proximity sensor 18 (gesture sensor), and a controller 11. The electronic device 1 further includes a UV sensor 19, an illuminance sensor 20, an acceleration sensor 21, a geomagnetic sensor 22, a barometric pressure sensor 23, and a gyro sensor 24. FIG. 1 is only an example, and the electronic device 1 need not include all of the components in FIG. 1. Also, the electronic device 1 may include components other than those illustrated in FIG. 1.

The timer 12 receives an instruction for a timer operation from the controller 11. Once a predetermined time has elapsed, the timer 12 outputs a signal indicating that the predetermined time has elapsed to the controller 11. The timer 12 may be provided independently from the controller 11, as illustrated in FIG. 1, or be configured internal to the controller 11.

The camera 13 captures images of subjects around the electronic device 1. One example of the camera 13 is a front camera provided on the same face as the display 14 of the electronic device 1.

The display 14 displays a screen. The screen includes, for example, at least one of characters, images, symbols, graphics, and the like. The display 14 may be a liquid crystal display, an organic electro-luminescence (EL) panel, an inorganic EL panel, or the like. In the present embodiment, the display 14 includes a touch sensor 14a and functions as a touch panel display (touchscreen display). The touch panel display detects contact by a finger, a stylus, or other object and identifies the contact position. The display 14 can simultaneously detect a plurality of positions contacted by fingers, styli, or other objects. The touch sensor 14a may, for example, use a capacitive method capable of detecting a touch, and the position thereof, on the basis of a change in the capacitance.

The microphone 15 detects sound around the electronic device 1, including people's voices.

The storage 16 functions as a memory storing programs and data. The storage 16 temporarily stores the processing results of the controller 11. The storage 16 may include any appropriate storage device, such as a semiconductor storage device or a magnetic storage device. The storage 16 may also include a plurality of types of storage devices. The storage 16 may include a combination of a portable storage medium, such as a memory card, and an apparatus for reading the storage medium.

The programs stored in the storage 16 include applications that run in the foreground or the background and a control program that supports operations of the applications. For example, the applications cause the controller 11 to execute processing corresponding to a gesture. The control program is, for example, an operating system (OS). The applications and control program may be installed on the storage 16 by communication through the communication interface 17 or from a storage medium.

The communication interface 17 is for communicating over a wired or wireless connection. The communication method of the communication interface 17 in an embodiment is prescribed by a wireless communication standard. For example, wireless communication standards include cellular phone communication standards such as 2G, 3G, or 4G. Examples of cellular phone communication standards include long term evolution (LTE), wideband code division multiple access (W-CDMA), CDMA2000, personal digital cellular (PDC), global system for mobile communications (GSM® (GSM is a registered trademark in Japan, other countries, or both)), and personal handy-phone system (PHS). Examples of wireless communication standards include worldwide interoperability for microwave access (WiMAX), IEEE802.11, Bluetooth® (Bluetooth is a registered trademark in Japan, other countries, or both), infrared data association (IrDA), and near field communication (NFC). The communication interface 17 may support one or more of the aforementioned communication standards.

The speaker 25 outputs sound. During a phone conversation, for example, the speaker 25 outputs the other party's voice. When, for example, the news, the weather forecast, or the like is read aloud, the speaker 25 outputs the corresponding sound.

Without contact, the proximity sensor 18 detects the relative distance to an object near the electronic device 1, the movement direction of the object, and the like. In the present embodiment, the proximity sensor 18 includes one infrared light emitting diode (LED) acting as a light source and four infrared photodiodes. The proximity sensor 18 emits infrared light, from the infrared LED acting as a light source, towards an object. Reflected light from the object is incident on the infrared photodiodes of the proximity sensor 18. The proximity sensor 18 can measure the relative distance to the object on the basis of the output current of the infrared photodiodes. The proximity sensor 18 also detects the movement direction of the object by the difference in time at which reflected light from the object is incident on each of the infrared photodiodes. The proximity sensor 18 can thus detect an operation by an air gesture (gesture) that the user of the electronic device 1 performs without touching the electronic device 1. The proximity sensor 18 may include visible light photodiodes. In the present embodiment, the proximity sensor 18 is provided on the same surface of the electronic device 1 on which the display 14 (touch sensor 14a) is provided.

The controller 11 is a processor such as a central processing unit (CPU). The controller 11 may be a system-on-a-chip (SoC) or other type of integrated circuit in which other components are integrated. The controller 11 may be configured by combining a plurality of integrated circuits. The controller 11 implements a variety of functions by controlling overall operation of the electronic device 1.

Specifically, the controller 11 refers as necessary to data stored in the storage 16. The controller 11 implements a variety of functions by executing instructions included in programs stored in the storage 16 to control other functional components, such as the display 14. For example, the controller 11 acquires data indicating contact by the user from the touch panel, acquires information on a user gesture detected by the proximity sensor 18, acquires information such as the remaining time in the countdown (the timer's time) from the timer 12, and recognizes the running status of an application.

The UV sensor 19 can measure the amount of ultraviolet light included in sunlight or other light.

The illuminance sensor 20 detects the illuminance from surrounding light that is incident on the illuminance sensor 20.

The acceleration sensor 21 detects the direction and magnitude of acceleration acting on the electronic device 1. The acceleration sensor 21 is, for example, a three-axis (3D) sensor that detects acceleration in the x-axis, y-axis, and z-axis directions. The acceleration sensor 21 may, for example, be a piezoresistive type or capacitive type of sensor.

The geomagnetic sensor 22 allows measurement of the orientation of the electronic device 1 by detecting the orientation of the earth's magnetic field.

The barometric pressure sensor 23 detects the barometric pressure outside of the electronic device 1 (atmospheric pressure).

The gyro sensor 24 detects the angular velocity of the electronic device 1. The controller 11 can measure the change in orientation of the electronic device 1 by integrating the angular velocity, acquired by the gyro sensor 24, over time.

(Electronic Device Gesture Operation)

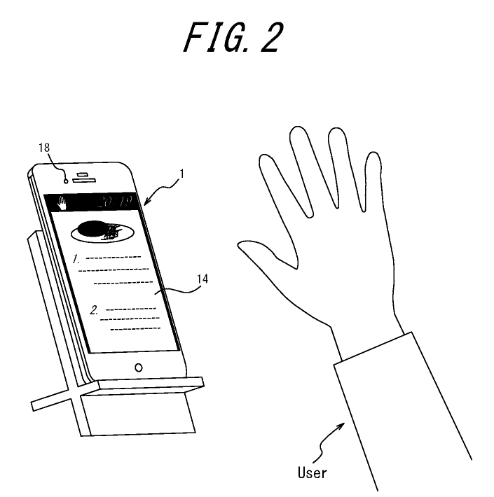

FIG. 2 illustrates the user operating the electronic device 1 with a gesture. In FIG. 2, the electronic device 1 is supported by a stand as an example. Alternatively, the electronic device 1 may be leaned against a wall or placed on a table. Upon the proximity sensor 18 detecting a gesture by the user, the controller 11 executes processing in response to the detected gesture. In the example in FIG. 2, the processing in response to the gesture is scrolling of the screen displaying a recipe. For example, when the user makes a gesture by moving a hand upward in the longitudinal direction of the electronic device 1, the screen scrolls upward in accordance with the movement of the user's hand. When the user makes a gesture by moving a hand downward in the longitudinal direction of the electronic device 1, the screen scrolls downward in accordance with the movement of the user's hand.

The electronic device 1 in FIG. 2 is a smartphone. Alternatively, the electronic device 1 may, for example, be a mobile phone, a phablet, a tablet PC, a feature phone, or other such device. The electronic device 1 is not limited to these examples and may, for example, also be a personal digital assistant (PDA), a remote control, a portable music player, a game device, an electronic book reader, a car navigation device, a household appliance, an industrial device (factory automation (FA) device), or the like.

(Gesture Detection Method)

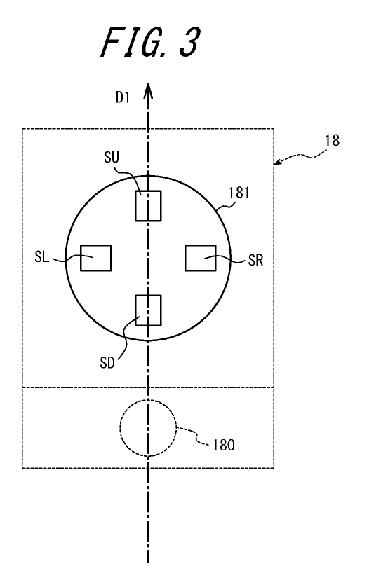

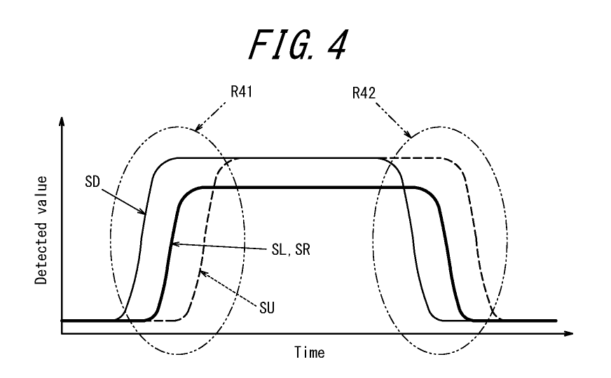

A method performed by the controller 11 to detect a gesture by the user on the basis of output of the proximity sensor 18 is described below in detail with reference to FIGS. 3 and 4. FIG. 3 illustrates an example configuration of the proximity sensor 18 when the electronic device 1 is viewed from the front. The proximity sensor 18 includes an infrared LED 180 acting as a light source and four infrared photodiodes SU, SR, SD, and SL. The four infrared photodiodes SU, SR, SD, and SL detect reflected light from a detection target through a lens 181. The four infrared photodiodes SU, SR, SD, and SL are arranged symmetrically around the center of the lens 181. The imaginary line D1 illustrated in FIG. 3 is roughly parallel to the longitudinal direction of the electronic device 1. The infrared photodiode SU and the infrared photodiode SD are placed apart on the imaginary line D1 in FIG. 3. The infrared photodiodes SR and SL are placed between the infrared photodiode SU and the infrared photodiode SD in the direction of the imaginary line D1 in FIG. 3.

FIG. 4 illustrates the change over time in the value detected by the four infrared photodiodes SU, SR, SD, and SL as the detection target (for example, the user's hand) moves in the direction of the imaginary line D1 in FIG. 3. The infrared photodiode SU and the infrared photodiode SD are separated the most in the direction of the imaginary line D1. Hence, as illustrated in FIG. 4, the time difference is greatest between the change (for example, increase) in the value detected by the infrared photodiode SU (dashed line) and the same change (for example, increase) in the value detected by the infrared photodiode SD (thin, solid line). By recognizing a predetermined time difference in the change in the value detected by the infrared photodiodes SU, SR, SD, and SL, the controller 11 can judge the movement direction of the detection target.

The controller 11 acquires the value detected by the infrared photodiodes SU, SR, SD, and SL from the proximity sensor 18. To recognize movement by the detection target in the direction of the imaginary line D1, for example, the controller 11 may integrate the result of subtracting the value detected by the photodiode SU from the value detected by the photodiode SD over a predetermined time. In the example in FIG. 4, the integral value in regions R41 and R42 is non-zero. From the change in the integral value (for example, a positive, zero, or negative change), the controller 11 can recognize movement of the detection target in the direction of the imaginary line D1.

The controller 11 may also integrate the result of subtracting the value detected by the photodiode SR from the value detected by the photodiode SL over a predetermined time. From the change in the integral value (for example, a positive, zero, or negative change), the controller 11 can recognize movement of the detection target in a direction orthogonal to the imaginary line D1 (a direction substantially parallel to the transverse direction of the electronic device 1).

Alternatively, the controller 11 may perform calculations using all of the detected values of the photodiodes SU, SR, SD, and SL. In other words, the controller 11 may recognize the movement direction of the detection target without performing calculations to divide the movement direction into components in the longitudinal direction and the transverse direction of the electronic device 1.

The detected gesture may be a left or right gesture, an up or down gesture, a diagonal gesture, a gesture to trace a circle clockwise, a gesture to trace a circle counterclockwise, or other such gesture. For example, the left or right gesture is performed in a direction roughly parallel to the transverse direction of the electronic device 1. The up or down gesture is performed in a direction roughly parallel to the longitudinal direction of the electronic device 1. The diagonal gesture is performed in a plane roughly parallel to the electronic device 1 in a direction not parallel to either the longitudinal direction or the transverse direction of the electronic device 1.

(Kitchen Mode)

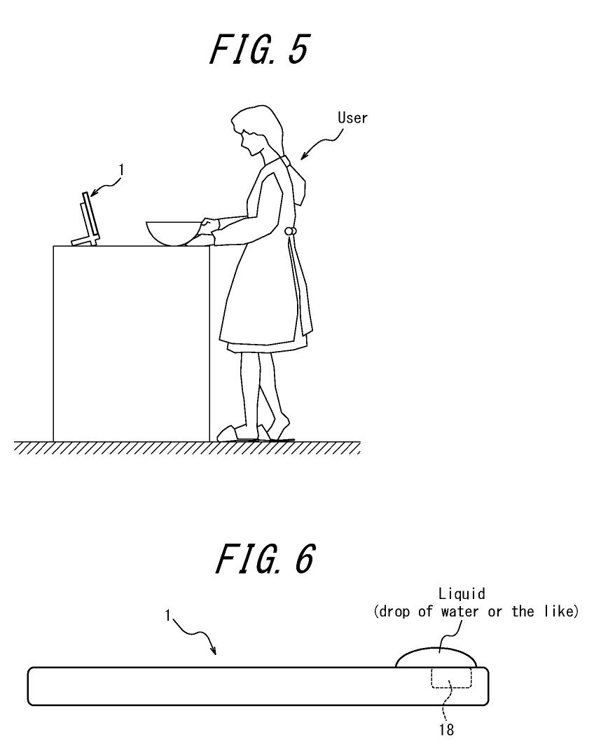

FIG. 5 illustrates an example of conditions in which the user operates the electronic device 1 with a gesture. In the example in FIG. 5, the user is cooking in the kitchen by following a cooking recipe displayed on the display 14 of the electronic device 1. At this time, the proximity sensor 18 detects a gesture by the user. The controller 11 executes processing in response to the gesture detected by the proximity sensor 18. For example, the controller 11 can execute processing to scroll the recipe in response to a particular gesture (such as the user moving the hand up or down). The user's hand may become dirty or wet while cooking. The user can scroll the recipe, however, without touching the electronic device 1. The display 14 therefore does not become dirty, and dirt on the display 14 can be prevented from getting on the user's hand during cooking.

The electronic device 1 has a plurality of modes. Modes refer to operation modes (operating states or operation statuses) that, for example, place restrictions on the operations of the entire electronic device 1. Only one mode can be selected at a time. In the present embodiment, the modes of the electronic device 1 include a first mode and a second mode. The first mode is a regular operation mode (regular mode) appropriate for use in rooms other than the kitchen or outside of the home, for example. The second mode is an operation mode (kitchen mode) optimal for cooking in the kitchen while a recipe is displayed. As described above, input operations can preferably be made by gestures in the second mode. In other words, when the mode of the electronic device 1 switches to the second mode, the proximity sensor 18 preferably operates in accordance with the switching to allow detection of a gesture. By including the below-described user interface, the electronic device 1 of the present embodiment can operate the proximity sensor 18 in accordance with switching to the second mode (kitchen mode).

(Proximity Sensor On/Off Control)

The electronic device 1 detects gestures using the proximity sensor 18, as described above. The electronic device 1 detects gestures by causing the proximity sensor 18 to detect infrared light that is emitted from the proximity sensor 18 and then reflected back. Consequently, if liquid such as water is present on the electronic device 1 at the location where the proximity sensor 18 is disposed, as illustrated schematically in FIG. 6, for example, then the infrared light may be defused or refracted by the liquid. The intensity, angle, and the like of the reflected light incident on the proximity sensor 18 may therefore change, preventing the electronic device 1 from detecting the user's gesture accurately. If the controller 11 performs control on the basis of a gesture detected while the liquid is present at the location where the proximity sensor 18 is disposed, a different operation than the one intended by the user might be executed. The electronic device 1 could thus operate erroneously in some cases.

The electronic device 1 according to the present embodiment detects gestures in the kitchen mode, as described in the above example. It is assumed that in the kitchen mode, the electronic device 1 is placed in the kitchen where the user is cooking, leading to a relatively high chance of liquid being present at the location where the proximity sensor 18 is disposed. It is therefore considered that the likelihood of erroneous operation in the kitchen mode is also high.

When the controller 11 in the electronic device 1 according to the present embodiment determines that liquid is present at the location where the proximity sensor 18 is disposed, the controller 11 suspends operation of (turns off) the proximity sensor 18, thereby suspending gesture detection. The controller 11 may determine whether liquid is present at the location where the proximity sensor 18 is disposed on the basis of information that is input. The details of the method by which the controller 11 determines whether liquid is present are provided below. By turning the proximity sensor 18 off to suspend gesture detection when liquid is present, the controller 11 ceases to execute gesture-based control, thereby preventing erroneous operation.

After the controller 11 of the electronic device 1 determines that liquid is present at the location where the proximity sensor 18 is disposed and suspends gesture detection, the controller 11 may reactivate (turn on) the proximity sensor 18 and restart gesture detection when it is determined that liquid is no longer present at the location. When, for example, the user wipes off the liquid present on the electronic device 1 with a towel over the like, the cause of the above-described erroneous operation is removed. In this case, the controller 11 can restart gesture detection by automatically turning the proximity sensor 18 on. After the controller 11 determines that liquid is present at the location where the proximity sensor 18 is disposed and suspends gesture detection, the controller 11 may turn on the proximity sensor 18 and start to detect gestures again when the user performs an input operation input to start gesture detection.

(Method for Determining Presence of Liquid)

Next, a method is described by which the controller 11 determines whether liquid, such as water, is present at the location where the proximity sensor 18 is disposed. The controller 11 determines whether liquid is present at the location where the proximity sensor 18 is disposed on the basis of output from the touch sensor 14a. When liquid is present on the touch panel display, the capacitance of the touch sensor 14a changes due to the liquid. The controller 11 can determine that liquid is present on the touch panel display on the basis of the change in the capacitance of the touch sensor 14a. The controller 11 may then determine that liquid is present at the location where the proximity sensor 18 is disposed when liquid is present on the touch panel display.

In the present embodiment, the proximity sensor 18 is provided on the same surface of the electronic device 1 on which the touch panel display (touch sensor 14a) is provided. Consequently, when liquid is present on the touch panel display, it can be inferred that liquid might also be present at the location where the proximity sensor 18 is disposed. The controller 11 may therefore determine that liquid is present at the location where the proximity sensor 18 is disposed when it is determined that liquid is present on the touch panel display on the basis of output from the touch sensor 14a. When liquid is present on the touch panel display, the probability of liquid also being present at the location where the proximity sensor 18 is disposed increases by, for example, the proximity sensor 18 being disposed near the touch sensor 14a. Because of this increased probability, the proximity sensor 18 may be disposed near the touch sensor 14a.

The capacitance of the touch sensor 14a also changes when, for example, the user touches the touch panel display with a finger. The controller 11 determines whether the change in the capacitance of the touch sensor 14a is a result of a touch by a finger or the presence of liquid. The controller 11 can determine that liquid is present at the location where the proximity sensor 18 is disposed when the change in the capacitance of the touch sensor 14a is a change in capacitance due to the presence of liquid.

The difference between the change in capacitance due to a touch by the user's finger and the change in capacitance due to the presence of liquid, along with the control by the controller 11 on the basis of this difference, is described now. A case in which the liquid is drops of water is described as an example, but the liquid is not limited to being water.

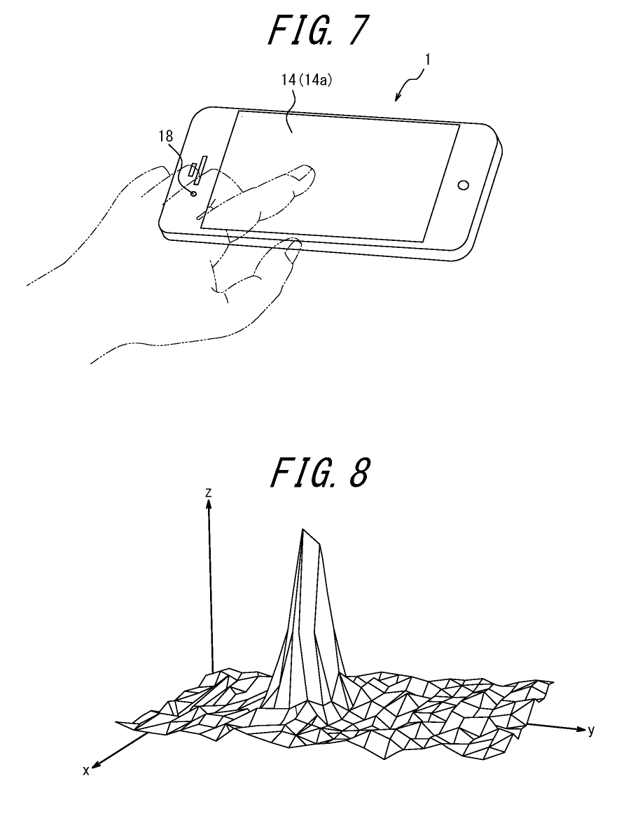

FIG. 7 illustrates an example of one finger touching the touch panel display of the electronic device 1. FIG. 8 illustrates an example distribution of the capacitance detected by the touch sensor 14a in the state illustrated in FIG. 7. In FIG. 8, the xy-plane corresponds to the plane of the touch sensor 14a. In FIG. 8, the change in capacitance due to a touch by the finger is indicated in the positive direction of the z-axis (the same holds below in the present disclosure). When the tip of one finger is touching the touch panel display, as illustrated in FIG. 7, the touch sensor 14a is affected by an increase in capacitance from the finger, which is a conductor. Consequently, as illustrated in FIG. 8, the capacitance at the position touched by the finger increases in the touch sensor 14a. In other words, when the tip of one finger is touching the touch panel display, a peak in the positive direction of the capacitance is detected at one location on the touch sensor 14a corresponding to the touched location.

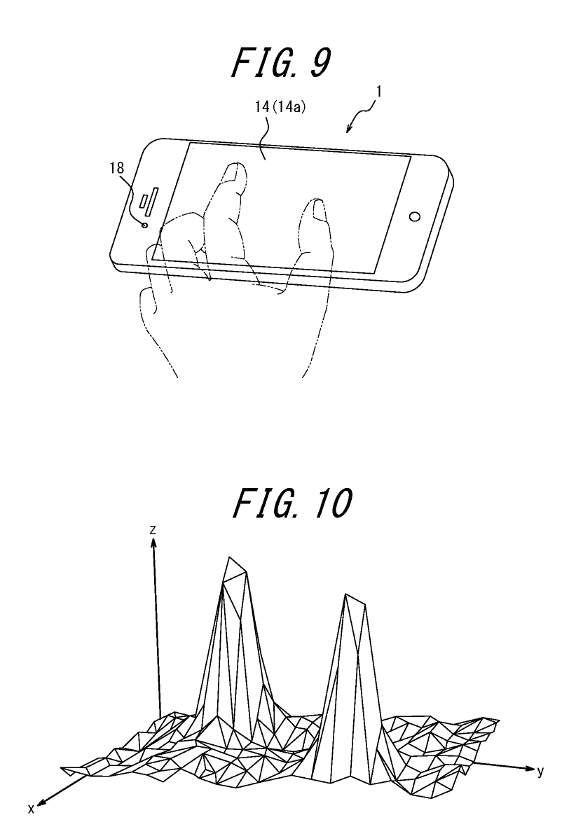

FIG. 9 illustrates an example of two fingers touching the touch panel display of the electronic device 1. FIG. 10 illustrates an example distribution of the capacitance detected by the touch sensor 14a in the state illustrated in FIG. 9. When the tips of two fingers are touching the touch panel display as illustrated in FIG. 9, the capacitance at the positions touched by the fingers increases in the touch sensor 14a, as illustrated in FIG. 10. In other words, when the tips of two fingers are touching the touch panel display, peaks in the positive direction of the capacitance are detected at two locations on the touch sensor 14a corresponding to the touched locations.

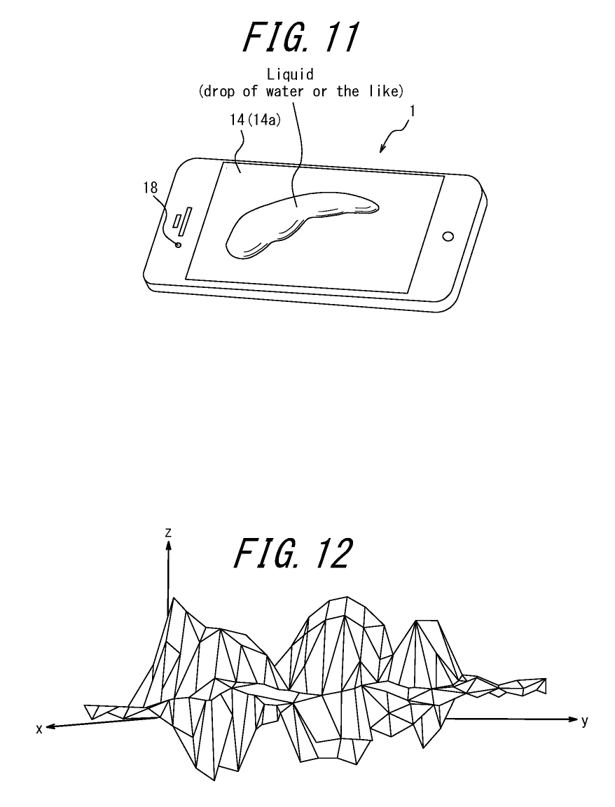

FIG. 11 illustrates an example of water being present on the touch panel display of the electronic device 1. FIG. 12 illustrates an example distribution of the capacitance detected by the touch sensor 14a in the state illustrated in FIG. 11. FIG. 11 illustrates a state in which a single drop of water is present on the touch panel display. In this case, the touch sensor 14a is affected by an increase in capacitance, due to the drop of water, at the periphery of the drop of water on the touch panel display. Consequently, as illustrated in FIG. 12, the capacitance at the periphery of the drop of water increases in the touch sensor 14a. On the other hand, in the central portion surrounded by the periphery of the drop of water on the touch panel display, the touch sensor 14a is affected by a decrease in capacitance to maintain electrical equilibrium relative to the increase in capacitance at the periphery. Consequently, as illustrated in FIG. 12, the capacitance at the central portion of the drop of water decreases in the touch sensor 14a. When a drop of water is present on the touch panel display, a peak in the positive direction of the capacitance is thus detected by the touch sensor 14a at the periphery, and a peak in the negative direction of the capacitance is detected at the central portion.

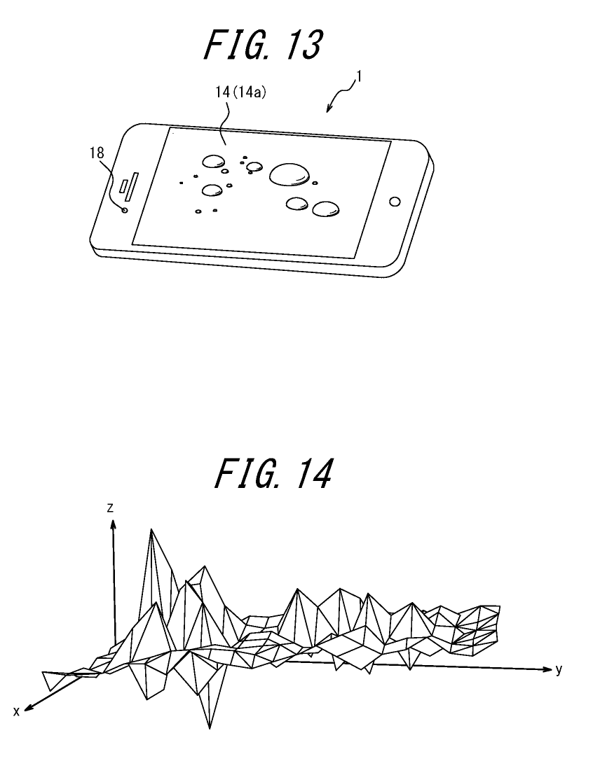

FIG. 13 illustrates another example of water being present on the touch panel display of the electronic device 1. FIG. 14 illustrates an example distribution of the capacitance detected by the touch sensor 14a in the state illustrated in FIG. 13. FIG. 13 illustrates a state in which a plurality of drops of water is present on the touch panel display. In this case, for similar reasons as those described with reference to FIG. 12, the capacitance at the periphery of each drop of water increases in the touch sensor 14a, as illustrated in FIG. 14. As illustrated in FIG. 14, the capacitance at the central portion of each drop of water decreases in the touch sensor 14a. In other words, when a plurality of drops of water is present on the touch panel display, a peak in the positive direction of the capacitance is thus detected by the touch sensor 14a at the periphery of each drop of water, and a peak in the negative direction of the capacitance is detected at the central portion of each drop of water.

As described with reference to FIG. 7 through FIG. 14, a change in the capacitance in one direction (positive direction) is detected when a finger touches the touch panel display. In contrast, changes in capacitance in the same direction (positive direction) and the opposite direction (negative direction) as the change in capacitance when a finger is touching are detected when a drop of water is present on the touch panel display. On the basis of these properties, the controller 11 can determine that liquid is present when the touch sensor 14a detects a change in capacitance corresponding to the case of a touching finger and a change in capacitance in the opposite direction.

When a drop of water is present on the touch panel display, the area on the touch panel display occupied by the drop of water may, depending on the amount of water, be greater than the contact area when a finger touches the touch panel display. For example, the area of the drop of water on the touch panel display in FIG. 11 and FIG. 12 may be greater than the contact area of the finger touching the touch panel display in FIG. 7 and FIG. 8. On the basis of this property, the controller 11 can determine that liquid is present when the touch sensor 14a detects a change in capacitance over a continuous area equal to or greater than a predetermined area. This is because a change in capacitance over a continuous area equal to or greater than a predetermined area can be determined as not being due to touch by a finger. The predetermined area may be set in advance in the electronic device 1 and stored in the storage 16, for example, as an area that is greater than the contact area of a finger when a finger touches the touch panel display.

When a plurality of drops of water is present on the touch panel display, the touch sensor 14a might, depending on the number of drops of water, detect a change in capacitance at a number of locations exceeding the number of locations at which a change in capacitance could be detected when fingers touch the touch panel display. For example, when a plurality of drops of water is present on the touch panel display as illustrated in FIG. 13 and FIG. 14, a change in capacitance is detected at more locations than when two fingers touch the touch panel display, as illustrated in FIG. 9 and FIG. 10. The number of locations at which a change in capacitance could be detected when fingers touch the touch panel display is the number of fingers that simultaneously touch the touch panel display during normal operation of the electronic device 1. The number of locations at which a change in capacitance could be detected when fingers touch the touch panel display may be set in advance, for example to a maximum of two or three locations, on the basis of a function of the electronic device 1 or may be settable by the user. On the basis of this property, the controller 11 can determine that liquid is present when the touch sensor 14a detects a change in capacitance at a predetermined number or greater of locations. This is because a change in capacitance at a predetermined number or greater of locations can be determined as not being due to touch by fingers.

When a finger is touching the touch panel display, the pressing force of the finger on the touch panel display changes easily. The capacitance detected by the touch sensor 14a also changes in accordance with the pressing force of the finger on the touch panel display. In contrast, when a drop of water is present on the touch panel display, the capacitance detected by the touch sensor 14a does not change unless the state of the drop of water on the touch panel display changes. In other words, when liquid is present on the touch panel display, the capacitance detected by the touch sensor 14a changes less easily over a short time than when a finger is touching the touch panel display. On the basis of this property, the controller 11 can determine that liquid is present when the change of capacitance detected by the touch sensor 14a does not vary for a predetermined length of time or longer. The predetermined length of time may be a length of time in which a change in pressure due to contact by a finger can be distinguished. The predetermined length of time may be set in advance in the electronic device 1 and stored, for example, in the storage 16.

The controller 11 may detect the presence of a liquid with any combination of the above-described methods. The presence of a liquid can be detected more accurately by combining a plurality of methods.

(Processing Flow Executed by Controller)

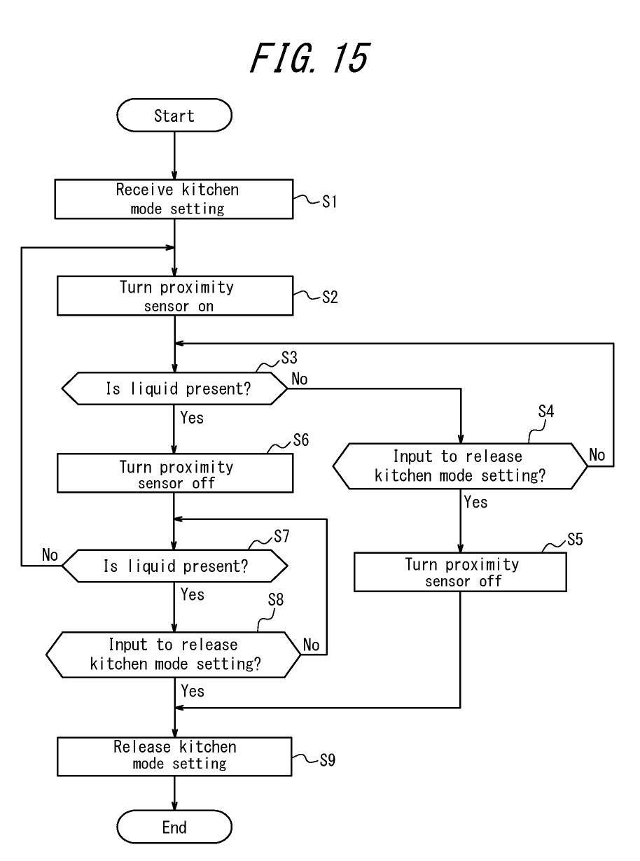

FIG. 15 is a flowchart illustrating an example of processing executed by the controller 11 of the electronic device 1.

Upon the user performing an input operation to set the electronic device 1 to the kitchen mode, the controller 11 receives the kitchen mode setting performed by the user (step S1).

The controller 11 turns the proximity sensor 18 on (step S2). Once the proximity sensor 18 is on, the controller 11 can detect a user gesture on the basis of output from the proximity sensor 18.

The controller 11 determines whether liquid is present at the location where the proximity sensor 18 is disposed (step S3). The controller 11 may determine whether liquid is present with the above-described method.

When the controller 11 determines that liquid is not present (step S3: No), the controller 11 determines whether the user has provided operation input to release the kitchen mode setting (step S4).

When the controller 11 determines that operation input to release the kitchen mode setting has not been provided (step S4: No), the processing transitions to step S3.

When the controller 11 determines that operation input to release the kitchen mode setting has been provided (step S4: Yes), the controller 11 turns the proximity sensor 18 off (step S5).

In this case, the controller 11 releases the kitchen mode setting (step S9) and terminates this processing flow.

On the other hand, when the controller 11 determines in step S3 that liquid is present (step S3: Yes), the controller 11 turns the proximity sensor 18 off (step S6). The detection of gestures is thus suspended in the electronic device 1.

While operation of the proximity sensor 18 is suspended, the controller 11 determines whether liquid is present at the location where the proximity sensor 18 is disposed (step S7).

When determining that liquid is not present (step S7: No), the controller 11 transitions to step S2 and turns the proximity sensor 18 on. In other words, in this case, the controller 11 can recognize that the liquid has been removed, for example by being wiped off, and can turn the proximity sensor 18 on to restart detection of gestures.

When the controller 11 determines that liquid is present (step S7: Yes), the controller 11 determines whether the user has provided operation input to release the kitchen mode setting (step S8).

When the controller 11 determines that operation input to release the kitchen mode setting has not been provided (step S8: No), the processing transitions to step S7.

When the controller 11 determines that operation input to release the kitchen mode setting has been provided (step S8: Yes), the controller 11 releases the kitchen mode setting (step S9) and terminates this processing flow.

As described above, the electronic device 1 according to the present embodiment turns the proximity sensor 18 off when determining, on the basis of output of the touch sensor 14a, that liquid is present at the location where the proximity sensor 18 is disposed. When the probability of a gesture not being detected accurately is high, the electronic device 1 thus suspends gesture-based control. The electronic device 1 thereby facilitates prevention of erroneous operation during gesture-based input operation.

### Other Embodiments

Although the present disclosure has been described with reference to the accompanying drawings and examples, it is to be noted that various changes and modifications will be apparent to those skilled in the art based on the present disclosure. Therefore, such changes and modifications are to be understood as included within the scope of the present disclosure. For example, the functions and the like included in the various components, steps, and the like may be reordered in any logically consistent way. Furthermore, components, steps, and the like may be combined into one or divided.

For example, even when the controller 11 determines that liquid is present on the touch panel display with the above-described methods, the controller 11 may continue to detect gestures, without turning the proximity sensor 18 off, when it is determined that the amount of liquid is small. This is because the probability of liquid being present at the location where the proximity sensor 18 is disposed can be determined to be low when the amount of liquid on the touch panel display is small. By continuing to detect gestures, the electronic device 1 can prevent gesture-based operations from being suspended for the user due to the presence of a small amount of liquid.

In the above embodiment, the controller 11 has been described as functioning under the assumption that when liquid is present on the touch panel display, liquid might also be present at the location where the proximity sensor 18 is disposed. Depending on the structure of the electronic device 1, however, the controller 11 may determine directly whether liquid is present on the proximity sensor 18, rather than by indirect methods as described above. For example, when the touch sensor 14a is also disposed at the location where the proximity sensor 18 is disposed in the electronic device 1, the controller 11 can determine whether liquid is present at the location where the proximity sensor 18 is disposed on the basis of the output of the touch sensor 14a. In this case, the controller 11 may turn the proximity sensor 18 on or off on the basis of whether liquid is present at the location where the proximity sensor 18 is disposed.

In the above embodiment, the touch sensor 14a has been described as using a capacitive method, but the touch sensor 14a is not limited to this example. The touch sensor 14a may use any method capable of detecting the presence of liquid.

In the above embodiment, gestures have been described as being detected by the proximity sensor 18, but gestures do not necessarily have to be detected by the proximity sensor 18. Gestures may be detected by any non-contact sensor that can detect user gestures with any appropriate non-contact method. Examples of non-contact sensors include the camera 13 and the illuminance sensor 20.

Much of the subject matter of the present disclosure is described as a series of operations executed by a computer system and other hardware that can execute program instructions. Examples of the computer system and other hardware include a general-purpose computer, a personal computer (PC), a dedicated computer, a workstation, a personal communications system (PCS), a mobile (cellular) phone, a mobile phone with a data processing function, an RFID receiver, a game device, an electronic notepad, a laptop computer, a global positioning system (GPS) receiver, and other programmable data processing apparatuses. It should be noted that in each embodiment, various operations or control methods are executed by a dedicated circuit (for example, individual logical gates interconnected in order to execute a particular function) implementing program instructions (software), or by a logical block and/or program module or the like executed by one or more processors. The one or more processors that execute a logical block and/or program module or the like include, for example, one or more of a microprocessor, CPU, application specific integrated circuit (ASIC), digital signal processor (DSP), programmable logic device (PLD), field programmable gate array (FPGA), processor, controller, microcontroller, microprocessor, electronic device, other apparatus designed to be capable of executing the functions disclosed here, and/or a combination of any of the above. The embodiments disclosed here are, for example, implemented by hardware, software, firmware, middleware, microcode, or a combination of any of these. The instructions may be program code or a code segment for executing the necessary tasks. The instructions may be stored on a machine-readable, non-transitory storage medium or other medium. The code segment may indicate a combination of any of the following: procedures, functions, subprograms, programs, routines, subroutines, modules, software packages, classes, instructions, data structures, or program statements. The code segment may transmit and/or receive information, data arguments, variables, or memory content to or from another code segment or hardware circuit in order for the code segment to connect to another code segment or hardware circuit.

The storage 16 used here may also be configured as a computer-readable, tangible carrier (medium) in any of the categories of solid-state memory, magnetic disks, and optical discs. Data structures and an appropriate set of computer instructions, such as program modules, for causing a processor to execute the techniques disclosed herein are stored on these media. Examples of computer-readable media include an electrical connection with one or more wires, a magnetic disk storage medium, a magnetic cassette, a magnetic tape, or other magnetic or optical storage medium, such as a compact disc (CD), laser Disc®, digital versatile disc (DVD®), Floppy® disk, and Blu-ray Disc® (laser disc, DVD, floppy, and Blu-ray disc are registered trademarks in Japan, other countries, or both). Further examples include a portable computer disk, random access memory (RAM), read-only memory (ROM), rewritable programmable ROM such as erasable programmable read-only memory (EPROM), electrically erasable programmable read-only memory (EEPROM), or flash memory, another tangible storage medium that can store information, or a combination of any of these. The memory may be provided internal and/or external to a processor or processing unit. As used in the present disclosure, the term “memory” refers to all types of long-term storage, short-term storage, and volatile, non-volatile, or other memory. In other words, the “memory” is not limited to a particular type and/or number. The type of medium on which information is stored is not limited, either.

1. An electronic device comprising:
a proximity sensor;
a touch sensor near the proximity sensor; and
a controller configured to turn the proximity sensor off when it is determined that liquid is present on the electronic device at a location where the proximity sensor is disposed on the basis of an output of the touch sensor.

2. The electronic device of claim 1, wherein the controller determines that the liquid is present when the touch sensor detects a change in capacitance in an opposite direction from a change in capacitance detected upon the user touching the touch sensor.

3. The electronic device of claim 1, wherein the controller determines that the liquid is present when the touch sensor detects a change in capacitance over a continuous area equal to or greater than a predetermined area.

4. The electronic device of claim 1, wherein the controller determines that the liquid is present when the touch sensor detects a change in capacitance at a predetermined number or greater of locations.

5. The electronic device of claim 1, wherein the controller determines that the liquid is present when a change of capacitance detected by the touch sensor does not vary for a predetermined length of time or longer.

6. The electronic device of claim 1, wherein after the controller turns the proximity sensor off, the controller turns the proximity sensor on when it is determined, on the basis of output of the touch sensor, that liquid is not present at the location where the proximity sensor is disposed.

7. A non-transitory computer-readable recording medium including computer program instructions to be executed by an electronic device comprising a proximity sensor, a touch sensor near the proximity sensor, and a controller, the instructions causing the electronic device to:
turn the proximity sensor off when it is determined, using the controller, that liquid is present on the electronic device at a location where the proximity sensor is disposed on the basis of an output of the touch sensor.

8. A control method for an electronic device comprising a proximity sensor, a touch sensor near the proximity sensor, and a controller, the control method comprising:
turning the proximity sensor off when it is determined, using the controller, that liquid is present on the electronic device at a location where the proximity sensor is disposed on the basis of an output of the touch sensor.
